(19) United States
(12) Patent Application Publication
(10) Pub. No.: US 2023/0378419 A1
(43) Pub. Date: Nov. 23, 2023

(54) BATTERY PASTE APPLICATION HOPPER WITH AUTOMATED CONTROL OF PASTE FEED PARAMETERS

(71) Applicant: Wirtz Manufacturing Company, Inc., Port Huron, MI (US)

(72) Inventors: John W. Wirtz, II, Fort Gratiot, MI (US); Scott A. Mercurio, Clyde Twp., MI (US); Sergiu Nicoara, Port Huron, MI (US); Jonmarc J. F. Hewett, St Clair, MI (US)

(21) Appl. No.: 18/198,568

(22) Filed: May 17, 2023

Related U.S. Application Data
(60) Provisional application No. 63/342,661, filed on May 17, 2022.

(51) Int. Cl. H01M 4/04; H01M 4/20; B05C 1/02

(52) U.S. Cl. CPC H01M 4/0409; H01M 4/20; B05C 1/02

(57) ABSTRACT

A battery paste application machine is equipped with a battery paste application hopper assembly. The battery paste application machine can be employed in a larger manufacturing operation to produce lead-acid batteries. The battery paste application hopper assembly furnishes automated control of one or more parameters of battery paste delivery. Volume of battery paste at the time of delivery can be automatically controlled, pressure of battery paste at the time of delivery can be automatically controlled, or both volume and pressure can be automatically controlled. Depending on the parameters controlled, the battery paste application hopper assembly can include a housing, a paste delivery roller, a feed roller, a scraper bar, a first actuator, and/or a second actuator.

### CROSS-REFERENCE TO RELATED APPLICATION

This application claims the benefit of U.S. Provisional Patent Application No. 63/342,661, with a filing date of May 17, 2022, the contents of which are hereby incorporated by reference in their entirety.

### TECHNICAL FIELD

This disclosure relates generally to lead-acid battery manufacturing equipment and processes, and, more particularly to, battery paste material application machines and hoppers equipped therein.

### BACKGROUND

Lead-acid batteries are a common source of electrical energy and are often used as automotive batteries, marine batteries, consumer equipment batteries, industrial batteries, as well as in other applications. Among their components, lead-acid batteries include numerous plates that are assembled in a case and are made of lead or lead alloy metal grids with an electrochemically-active battery paste material applied on the grids. Somewhat early in manufacture, the grids are usually supplied in a continuous strip of individual cast grids connected together. The strip travels through a pasting machine and beneath a hopper where the battery paste material is applied to the grids. Battery paste hoppers hold a supply of battery paste material and steadily dispense sufficient amounts of the material to the strip of grids passing below. Rollers and paddles at an interior of battery paste hoppers and submerged in the battery paste material keep the material mixing and moving in the hoppers and incite dispensation of the battery paste material. Parameters of paste dispensation and flow to the grids can be governed, at least in part, by the arrangement of internal components of the battery paste hoppers such as its rollers. An example of a pasting machine is described in U.S. Pat. No. 9,437,867, assigned to Wirtz Manufacturing Company, Inc.

### SUMMARY

In an embodiment, a battery paste application hopper assembly may include a housing, a paste delivery roller, a feed roller, a scraper bar, and an actuator. The housing establishes an interior. The paste delivery roller is situated at the housing's interior. The feed roller is situated at the interior, and is located near the paste delivery roller. The scraper bar is situated at the interior, and is located downstream of a clearance that is established between the paste delivery roller and the feed roller. The actuator has a connection with the scraper bar. Actuation of the actuator prompts and incites rotation of the scraper bar.

In an embodiment, a battery paste application hopper assembly may include a housing, a paste delivery roller, a feed roller, and an actuator. The housing establishes an interior. The paste delivery roller is situated at the housing's interior. The feed roller is situated at the interior, and is located near the paste delivery roller. A clearance is established at a confrontation between the feed roller and the paste delivery roller. The actuator has a connection with the feed roller. The actuator is actuatable in order to rotate the feed roller about an eccentric axis. Rotation of the feed roller about the eccentric axis serves to adjust the clearance established between the feed roller and the paste delivery roller.

In an embodiment, a battery paste application hopper assembly may include a housing, a paste delivery roller, a feed roller, a scraper bar, a first actuator, and a second actuator. The housing establishes an interior. The paste delivery roller is situated at the housing's interior. The feed roller is located near the paste delivery roller. The feed roller has a first gear. A clearance is established at a confrontation between the feed roller and the paste delivery roller. The scraper bar is located downstream of the clearance, has a planar working surface, and has a second gear. The first actuator has a third gear. The first actuator is actuatable in order to rotate the feed roller about an eccentric axis via meshing of the first and third gears. Rotation of the feed roller about the eccentric axis serves to adjust the clearance. The second actuator has a fourth gear. The second actuator is actuatable in order to rotate the scraper bar via meshing of the second and fourth gears. Rotation of the scraper bar serves to adjust an angle of the planar working surface with respect to the feed roller.

### BRIEF DESCRIPTION OF THE DRAWINGS

Embodiments of the disclosure are described with reference to the appended drawings, in which:

FIG. 1 is a perspective view of an embodiment of a battery paste application hopper;

FIG. 2 is a perspective view of internal components of the battery paste application hopper;

FIG. 3 is another perspective view of the internal components;

FIG. 4 is another perspective view of the internal components;

FIG. 5 is a front view of the battery paste application hopper;

FIG. 6 is a sectional view taken at arrowed line 6-6 of FIG. 5;

FIG. 7 is a sectional view taken at arrowed line 7-7 of FIG. 5;

FIG. 8 is a sectional view taken at arrowed line 8-8 of FIG. 5; and

FIG. 9 is a sectional view taken at arrowed line 9-9 of FIG. 5.

### DETAILED DESCRIPTION

With reference to the figures, an embodiment of a battery paste application hopper assembly 10 (hereafter, “hopper assembly”) is presented that is equipped as part of a larger battery paste application machine. Unlike past battery paste hoppers, the hopper assembly 10 employs automated control of one or more parameters of electrochemically-active battery paste material (hereafter, “battery paste”) delivery and feeding to a continuous strip of lead or lead alloy metal grids traveling beneath the hopper assembly 10. A more effective and efficient battery paste application process is hence furnished. In the embodiment described herein, the parameters subject to automation include volume of battery paste at the time of delivery and discharge out of the hopper assembly 10 and to the underlying strip of grids, and pressure of battery paste at such delivery and discharge. The battery paste application machine and hopper assembly 10 can be employed in a larger manufacturing setup and process that produces lead-acid batteries for automotive applications, marine applications, consumer equipment applications, and industrial applications, among many other possibilities. Furthermore, as used herein, the terms upstream and downstream refer to directions with respect to the general and intended aggregate movement of battery paste within the hopper assembly 10 amid use.

In general, the battery paste application machine accepts reception of the strip of grids and applies battery paste to the strip of grids. Applying battery paste is but one step in the larger manufacturing setup and process. After pasting, the pasted strip of grids is ordinarily led to a severing procedure in which the pasted strip of grids is cut into individual pasted grids, and then to a flash drying process to remove moisture from the applied battery paste, among other possible steps in the larger manufacturing setup and process; still, preceding and following process step may vary. Individual grids are typically composed of a lead or lead alloy metal, and designed with a peripheral frame and crisscrossing horizontal and vertical wires interconnecting at nodes with open spaces among the wires for receipt of battery paste. Among its main components, the battery paste application machine includes a frame, a belt, and the hopper assembly 10. The frame furnishes a structural skeleton, and is commonly made-up of a multitude of vertical, side, and cross members of steel joined together. The belt carries the strip of grids through the battery paste application machine from an entry end to an exit end and beneath the hopper assembly 10. The belts are often endless and driven by a motor and one or more rollers that keep the belts taut.

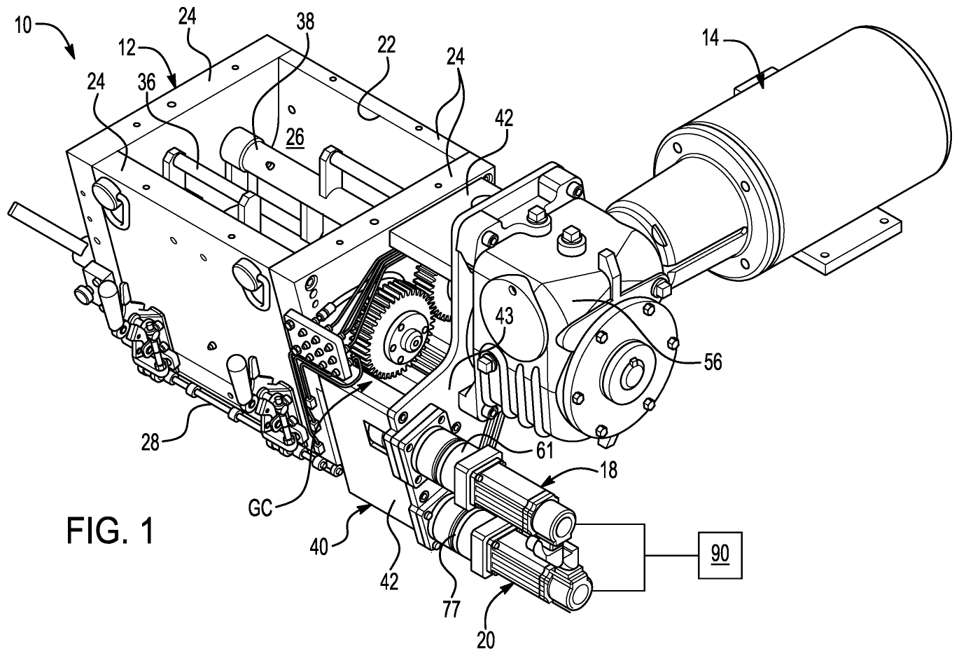

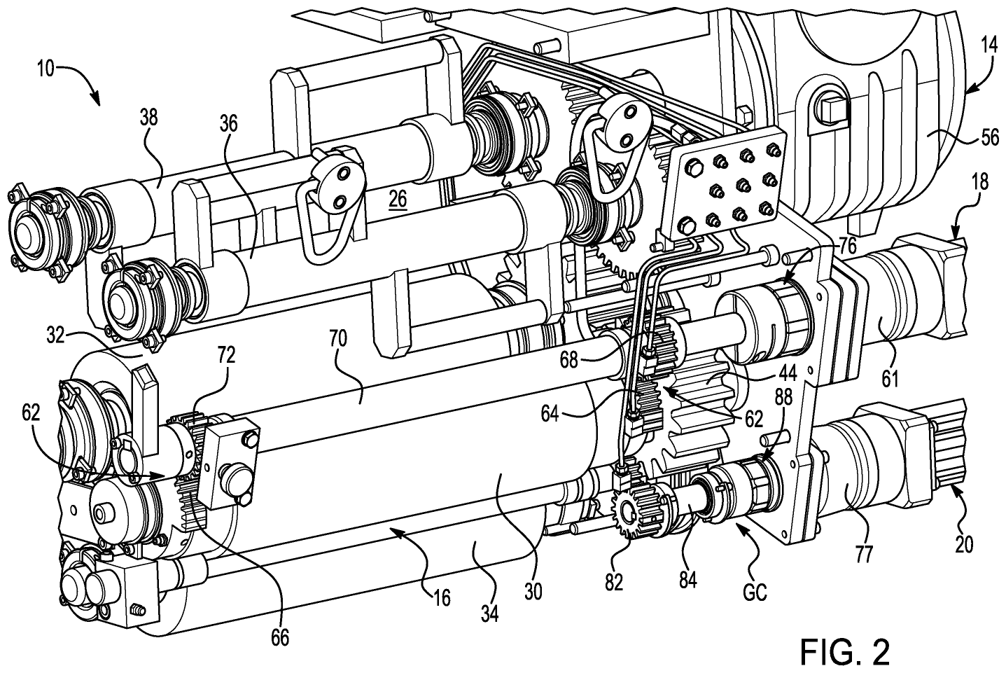

The hopper assembly 10 is supported by the frame at a location vertically above the belt, contains and holds a supply of battery paste, and dispenses the battery paste to the strip of grids carried by the belt below. The hopper assembly 10 can exhibit different designs, constructions, and components in various embodiments. In the embodiment presented by the figures, and with reference to FIGS. 1 and 2, the hopper assembly 10 generally includes a housing 12, rollers and paddles, a main motor 14, a scraper bar 16, a first actuator or servomotor 18, and a second actuator or servomotor 20; still, in other embodiments the hopper assembly 10 could include more, less, and/or different components than those described herein.

The housing 12 holds the supply of battery paste and has an open top 22 and multiple walls 24 at its sides. The walls 24 are four in total per this embodiment. An interior 26 is established by the housing 12 and by the walls 24. The supply of battery paste resides at the interior 26 during use of the hopper assembly 10. At a bottom 28, the housing 12 has an orifice plate mounted thereto. With the exception of an orifice slot, the orifice plate generally closes the bottom 28 of the housing 12. The orifice slot resides in the orifice plate and can have an elongated rectangular shape. The orifice slot fluidly communicates with the interior 26. Battery paste moves through and is fed out of the orifice slot to the strip of grids passing below amid use of the hopper assembly 10. Further, a depression can reside in a top surface of the orifice plate and, when present, resides in general confrontation with the housing's interior 26. The depression is shaped complementary to a paste delivery roller (introduced below) so that the roller can nest in the depression with a slight clearance maintained therebetween in assembly. The orifice slot has a location at the depression. Still, the housing 12 could have other constructions in other embodiments.

The rollers and paddles are submerged in the supply of battery paste and keep the battery paste mixing and moving at the housing's interior 26 and incite dispensation of the battery paste to the strip of grids at the bottom 28 of the housing 12. The rollers and paddles work together to facilitate aggregate movement of the battery paste downward toward the dispensation location of the hopper assembly 10. With reference to FIG. 2, in this embodiment the hopper assembly 10 is equipped with three rollers and two paddles: a first feed roller 30, a second feed roller 32, a paste delivery roller 34, a first paddle 36, and a second paddle 38; still, the rollers and paddles could have other types and quantities. The rollers and paddles are situated at the interior 26 and are all ganged together for rotational movement via a multitude of gears and chains. The gears and chains—generally indicated by arrowed line GC in FIG. 1—are situated at an exterior of the housing 12 and exterior of its walls 24. A second housing 40 with multiple walls 42 is mounted at a side of the housing 12. The second housing 40 partially encloses the gears and chains GC.

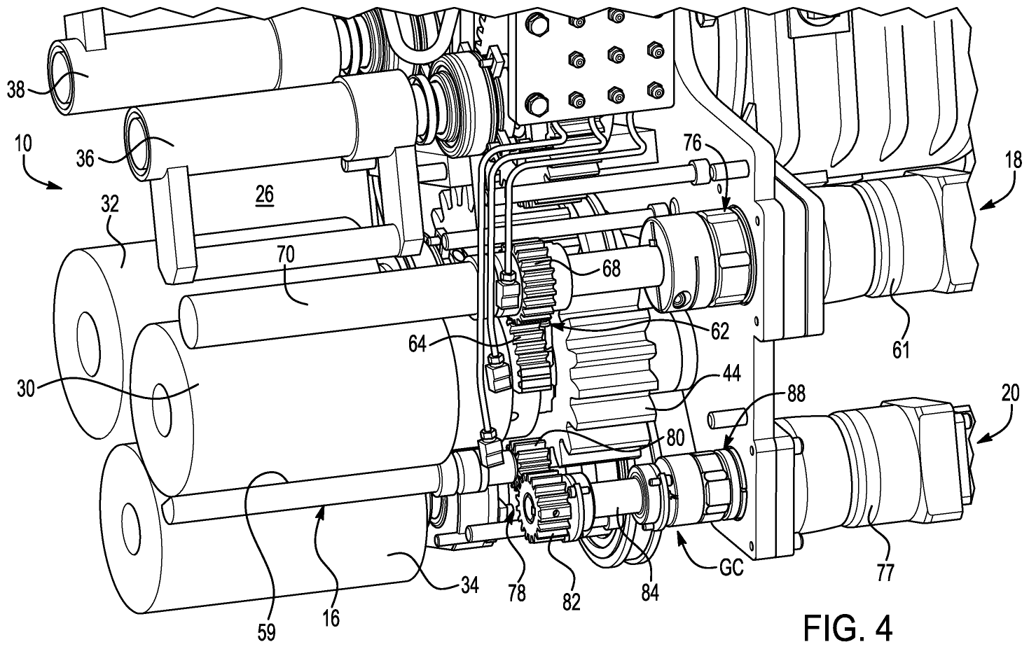

Referring now to FIGS. 2-4, the first and second feed rollers 30, 32, and the paste delivery roller 34, have a cylindrical shape and are elongated between axial and terminal ends. The first feed roller 30 rotates about its central axis CA1 in a direction D1 during use, and works to draw the general flow of battery paste in a downward direction and toward the housing's bottom 28. In a vertical direction, the first feed roller 30 is positioned between the second feed roller 32 and the paste delivery roller 34. A main gear 44 mounted to a main shaft of the first feed roller 30 receives rotational drive input from other gears and chains GC to cause rotation of the first feed roller 30 about the central axis CA1. Further, the second feed roller 32 rotates about its central axis CA2 in a direction D2 during use, and works to draw the general flow of battery paste in a downward direction. A main gear 46 mounted to a main shaft of the second feed roller 32 receives rotational drive input from other gears and chains GC to cause rotation of the second feed roller 32 about the central axis CA2. A clearance is established at a confrontation between the first and second feed rollers 30, 32 for the passage of battery paste being drawn therethrough.

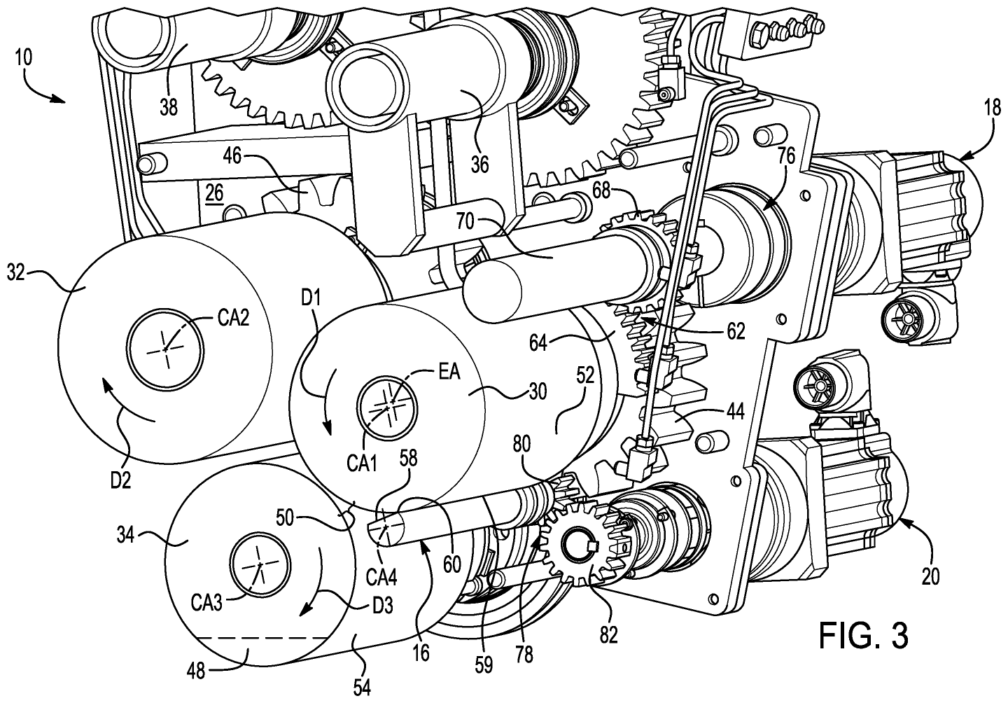

The paste delivery roller 34 has a lowermost position of the rollers in the interior 26. A bottom portion 48—denoted approximately by the broken line in FIG. 3—nests in the depression of the orifice plate, according to this embodiment. The paste delivery roller 34 rotates about its central axis CA3 in a direction D3 during use, and works to draw the general flow of battery paste through the orifice slot. A main gear mounted to a main shaft of the paste delivery roller 34 receives rotational drive input from other gears and chains GC to cause rotation of the paste delivery roller 34 about the central axis CA3. A clearance 50 is established at a confrontation between the first feed roller 30 and the paste delivery roller 34 for the passage of battery paste being drawn therethrough. The clearance 50 is defined at a gap between an outer surface 52 of the first feed roller 30 and an outer surface 54 of the paste delivery roller 34 at the confrontation. The clearance 50 can be measured as the shortest distance taken between the outer surfaces 52, 54. In example embodiments, the size of the clearance 50 can range between zero (0.000) and 0.092 inches; still, the size of the clearance 50 can vary in other example embodiments. The first and second paddles 36, 38 rotate about their central axes during use, and work to keep the battery paste mixing and moving in the interior 26 at a location above the rollers. Main gears mounted on main shafts of the first and second paddles 36, 38 receive rotational drive input from other gears and chains GC to cause rotation of the first and second paddles 36, 38 about their respective central axes.

The main motor 14 drives rotational movement of the rollers and paddles via a gearbox 56 amid operation of the battery paste application machine and use of the hopper assembly 10. The main motor 14 can be of the electric motor type.

The scraper bar 16 is situated just downstream of the clearance 50 and nestled adjacent the outer surface 52 of the first feed roller 30 in order to redirect battery paste movement following rotation of the first feed roller 30 adjacent the outer surface 52. The scraper bar 16 has an elongated extent similar to that of the first feed roller 30. In sectional profile, and as illustrated perhaps best by FIG. 3, the scraper bar 16 exhibits a half-round shape with a partially rounded side and a flat side. The flat side establishes a planar working surface 58 of the scraper bar 16. The planar working surface 58 confronts movement of battery paste and can be impinged by battery paste as the battery paste migrates through the interior 26. The planar working surface 58 generally lies in confrontation with the clearance 50 and with the outer surface 52 of the first feed roller 30. Depending on the angular and rotational position of the scraper bar 16 with respect to the first feed roller 30, a clearance 60 can develop and be established between a trailing edge 59 of the planar working surface 58 and the outer surface 52 of the first feed roller 30. The clearance 60 can be closed-off and absent, or developed to varying extents, depending on the scraper bar's position. When established, the clearance 60 can be measured as the shortest distance taken between the trailing edge 59 of the planar working surface 58 and the outer surface 52. In example embodiments, the size of the clearance 60 can range between zero (0.000) and 0.156 inches; still, the size of the clearance 60 can vary in other example embodiments.

The particular volume output of battery paste exiting and discharged from the orifice plate via the orifice slot, according to this embodiment, can be manipulated in part or more by the size and extent of the clearance 50 established between the first feed roller 30 and the paste delivery roller 34. Increased size generally corresponds to greater volume, and conversely, decreased size generally corresponds to lesser volume. Furthermore, the particular pressure output of battery paste exiting and discharged from the orifice plate via the orifice slot, according to this embodiment, can be manipulated in part or more by the angular and rotational position of the scraper bar 16 with respect to the first feed roller 30, and the concomitant extent of establishment and size, or non-establishment, of the clearance 60. When established, increased size generally corresponds to lesser pressure, and conversely, decreased size generally corresponds to greater pressure. Non-establishment also generally corresponds to greater pressure. In previous battery paste hoppers, if these volume and pressure parameters were capable of modification, it required manual hand/tool work and finetuning.

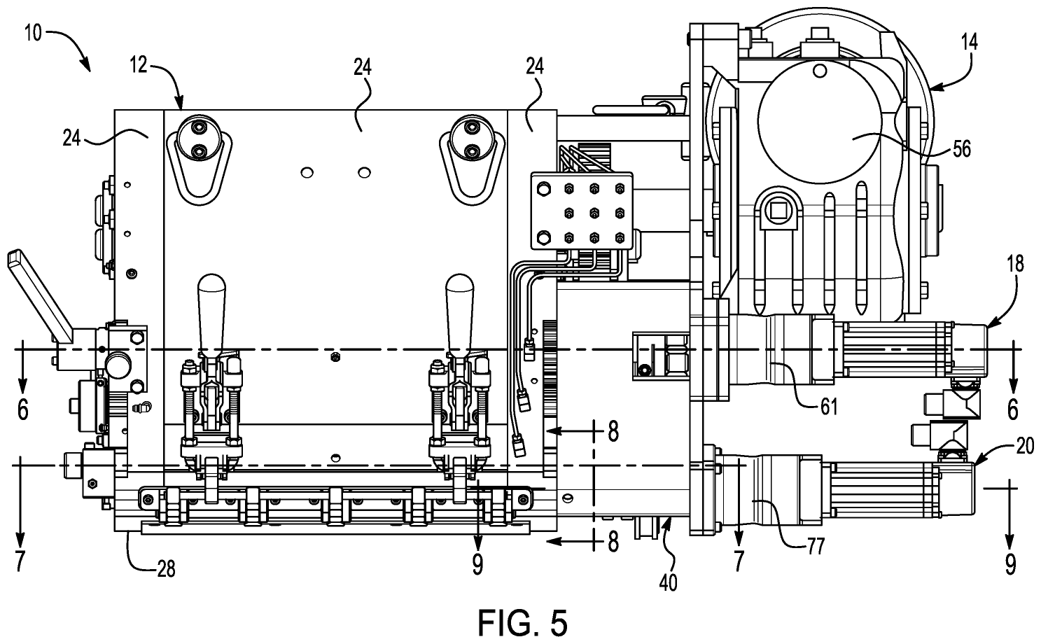

The first and second actuators 18, 20 automate aspects of parameter control. In the embodiment here, the first and second actuators 18, 20 are in the form of first and second servomotors 18, 20, but could take other forms in other embodiments. The first servomotor 18 is employed in order to facilitate automated control of volume of battery paste output and discharge from the battery paste application machine for dispensation to the strip of grids. The first servomotor 18 is actuated and deactuated amid its use. The first servomotor 18 is of the rotary actuated type according to this embodiment, but could be of another type in another embodiment. It is capable of precisely regulating angular position, velocity, and acceleration of its rotary output. In one example embodiment, the first servomotor 18 can be a VPL series and type servomotor supplied by company Allen-Bradley of Milwaukee, Wisconsin U.S.A; still, other servomotor products from other companies are possible in other example embodiments. With reference to FIGS. 1-5, in this embodiment the first servomotor 18 is located exteriorly of the housing 12 and is mounted to a side of the second housing 40 at an outer wall 43 via a flange mounting. Further, a first gearbox 61 is equipped at an output of the first servomotor 18 in order to effect increased torque output. In an example embodiment, the first gearbox 61 can be of the planetary type of gearbox and can be supplied by company Wittenstein SE of Igersheim, Germany; still, other gearbox products from other companies are possible in other example embodiments. The first servomotor 18 can be considered an upper servomotor due to its vertical position relative to the second servomotor 20.

The automated control of volume facilitated by the first servomotor 18 can be implemented and carried out in various ways according to different embodiments. In the embodiment of the figures, and with reference now to FIGS. 1-6, the first feed roller 30 is rotatable in both directions of rotation (i.e., clockwise and counterclockwise) about an eccentric axis EA via actuation of the first servomotor 18. The rotation can be over a range of approximately fifty-five degrees (55°) of rotation per an example embodiment; still, the range of rotation can vary in other example embodiments and could be greater than or less than 55°. This rotation is dissimilar from the full and continuous rotation of the first feed roller 30 about the central axis CA1 amid use. The eccentric axis EA is offset from the central axis CA1. In an example embodiment, the offset can measure approximately 0.125 inches; still, the amount of the offset and degree of eccentricity can vary in other example embodiments. Turning the first feed roller 30 about the eccentric axis EA in a first rotational direction brings the first feed roller 30 and paste delivery roller 34 farther apart, and spaces the outer surfaces 52, 54 farther apart. The clearance 50 is hence adjusted and increased in size, altering volume output of battery paste by an increased amount. Conversely, turning the first feed roller 30 about the eccentric axis EA in an opposite, second rotational direction brings the first feed roller 30 and paste delivery roller 34 closer together, and brings the outer surfaces 52, 54 closer together. The clearance 50 is hence adjusted and decreased in size, altering volume output of battery paste by a decreased amount.

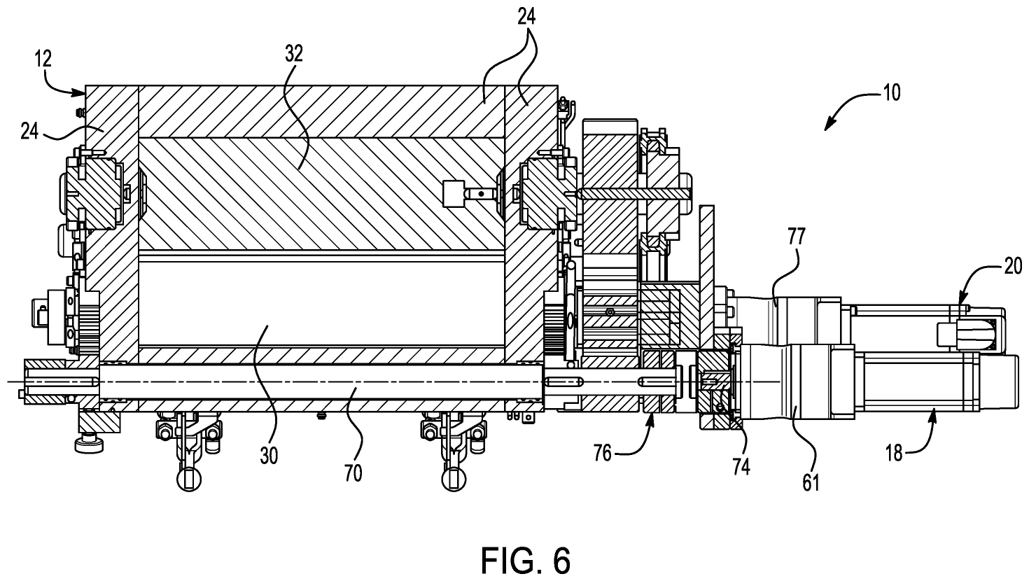

Rotation of the first servomotor 18 effects turning of the first feed roller 30 about the eccentric axis EA. A connection 62 is made between the first servomotor 18 and first feed roller 30 for this purpose. The connection 62 serves to transfer and transmit rotational drive of the first servomotor 18 to turning of the first feed roller 30 for adjustment purposes. In this embodiment, and with reference to FIGS. 2-4, the connection 62 is in the form of a mechanical interconnection between gears and meshing among gear teeth. A first gear 64 is mounted on a first side of the first feed roller 30, and a second gear 66 is mounted on a second, opposite side of the first feed roller 30. Both of the first and second gears 64, 66 have their respective axes of rotation coinciding, and in alignment with, each other and with the eccentric axis EA—indeed, in this regard, the axes of rotation of the first and second gears 64, 66 establish the eccentric axis EA. Since rotation of the first feed roller 30 about the eccentric axis EA is only a partial revolution and turn, and not a full three-hundred-and-sixty-degree (360°) rotation, the first and second gears 64, 66 can be of the half-moon gear type. Furthermore, in the formation of the connection 62, a third gear 68 is mounted on one side of an extended shaft 70, and a fourth gear 72 is mounted on an opposite side of the extended shaft 70. The axial positions of the third and fourth gears 68, 72 are in accordance with axial positions of the first and second gears 64, 66 so that teeth of the first and third gears 64, 68 can mesh with one another, and so that teeth of the second and fourth gears 66, 72 can mesh with one another. The extended shaft 70 is connected to an output shaft 74 (FIG. 6) of the first servomotor 18 via a coupling 76. The coupling 76, in this embodiment, is a vibration-damping flexible type of coupling and includes two hubs and a spider coupling. Axes of rotation of the extended shaft 70 and of the output shaft 74 coincide, and are in alignment with, each other. Conversely, the axes of rotation of the extended shaft 70 and of the output shaft 74 are offset from the eccentric axis EA and from the central axis CA1.

The second servomotor 20 is employed in order to facilitate automated control of pressure of battery paste output and discharge from the battery paste application machine for dispensation to the strip of grids. The second servomotor 20 is actuated and deactuated amid its use. The second servomotor 20 is of the rotary actuated type according to this embodiment, but could be of another type in another embodiment. It is capable of precisely regulating angular position, velocity, and acceleration of its rotary output. In one example embodiment, the second servomotor 20 can be a VPL series and type servomotor supplied by company Allen-Bradley of Milwaukee, Wisconsin U.S.A; still, other servomotor products from other companies are possible in other example embodiments. With reference to FIGS. 1-5, in this embodiment the second servomotor 20 is located exteriorly of the housing 12 and is mounted to a side of the second housing 40 at the outer wall 43 via a flange mounting. Further, a second gearbox 77 is equipped at an output of the second servomotor 20 in order to effect increased torque output. In an example embodiment, the second gearbox 77 can be of the planetary type of gearbox and can be supplied by company Wittenstein SE of Igersheim, Germany; still, other gearbox products from other companies are possible in other example embodiments. The second servomotor 20 can be considered a lower servomotor due to its vertical position relative to the first servomotor 18.

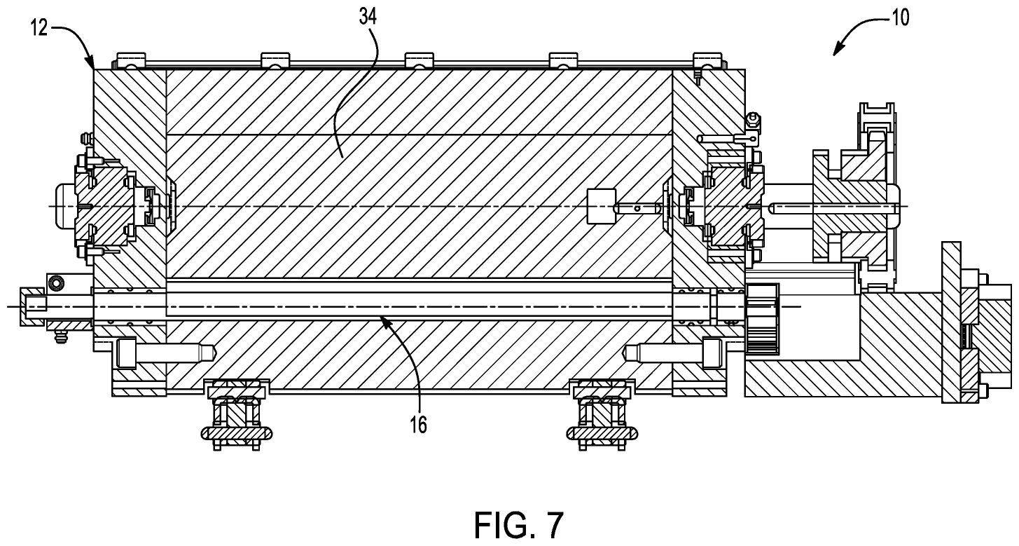

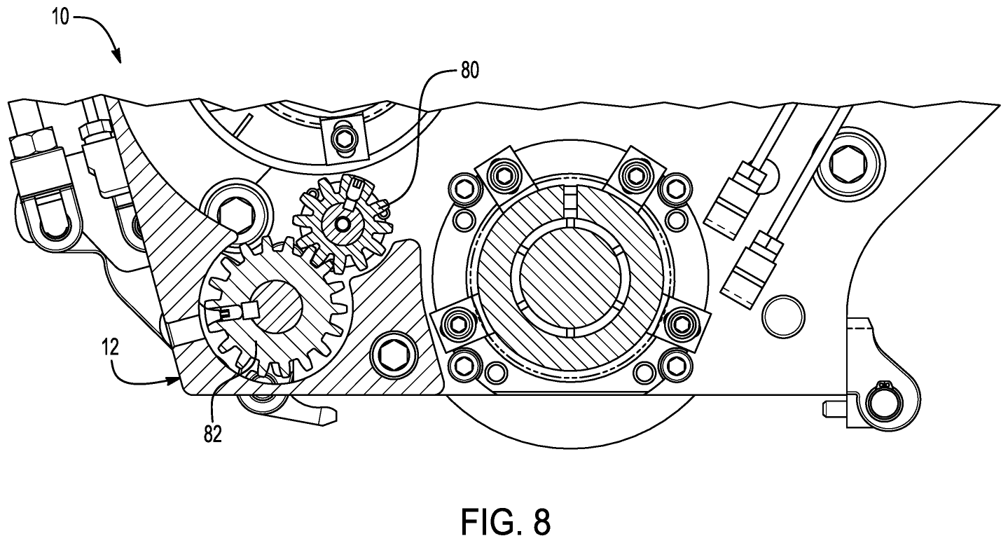

The automated control of pressure facilitated by the second servomotor 20 can be implemented and carried out in various ways according to different embodiments. In the embodiment of the figures, and with reference now to FIGS. 2, 3, 4, 7, and 8, the scraper bar 16 is rotatable in both directions of rotation (i.e., clockwise and counterclockwise) about its central axis CA4 via actuation of the second servomotor 20. The rotation can be over a range of approximately thirty-six degrees (36°) of rotation per an example embodiment; still, the range of rotation can vary in other example embodiments. Turning the scraper bar 16 about the central axis CA4 in a first rotational direction changes an angle defined between the planar working surface 58 and the outer surface 52 of the first feed roller 30, and changes the angular and rotational position of the scraper bar 16 relative to the first feed roller 30. The clearance 60 can hence be established, adjusted, and/or increased in size, altering pressure output of battery paste by a decreased amount. Conversely, turning the scraper bar 16 about the central axis CA4 in an opposite, second rotational direction changes the angle between the planar working surface 58 and the outer surface 52, and changes the angular and rotational position of the scraper bar 16 relative to the first feed roller 30. The clearance 60 can hence be closed-off, adjusted, and/or decreased in size, altering pressure output of battery paste by an increased amount.

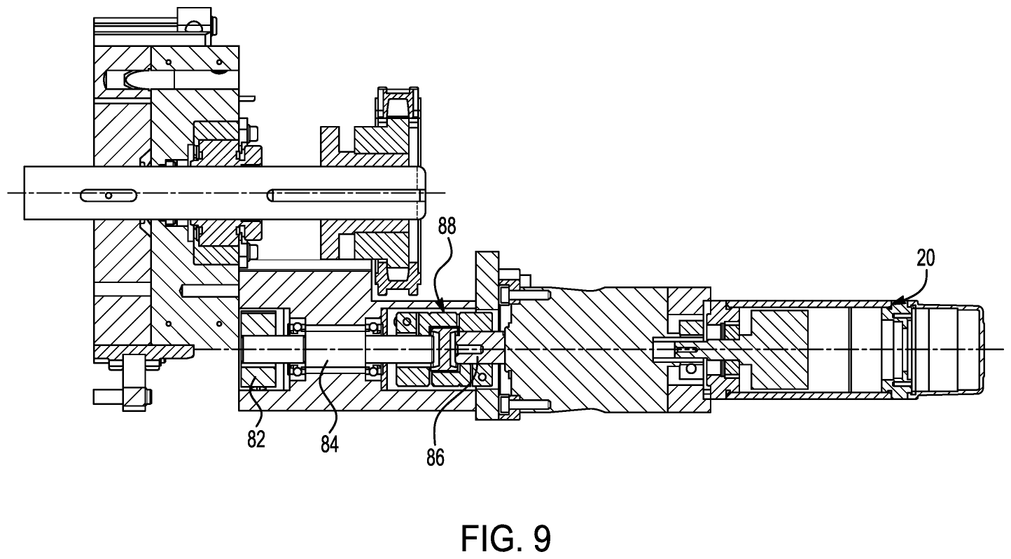

Rotation of the second servomotor 20 effects rotation of the scraper bar 16 about the central axis CA4. A connection 78 is made between the second servomotor 20 and scraper bar 16 for this purpose. The connection 78 serves to transfer and transmit rotational drive of the second servomotor 20 to turning of the scraper bar 16. In this embodiment, and with reference to FIGS. 2-4, 7, and 8, the connection 78 is in the form of a mechanical interconnection between gears and meshing among gear teeth. A single, first gear 80 is mounted adjacent a terminal end of the scraper bar 16. The first gear 80 has its axis of rotation coinciding, and in alignment with, the central axis CA4 of the scraper bar 16. Furthermore, a single, second gear 82 is mounted adjacent a terminal end of an extended shaft 84. The axial position of the first gear 80 is in accordance with the axial position of the second gear 82 so that teeth of the first and second gears 80, 82 can mesh with one another. The extended shaft 84 is connected to an output shaft 86 (FIG. 9) of the second servomotor 20 via a coupling 88. The coupling 88, in this embodiment, is a vibration-damping flexible type of coupling and includes two hubs and a spider coupling. Axes of rotation of the extended shaft 84 and of the output shaft 86 coincide, and are in alignment with, each other. Conversely, the axes of rotation of the extended shaft 84 and the output shaft 86 are offset from the central axis CA4 of the scraper bar 16.

The first and second servomotors 18, 20 can be furnished with closed-loop feedback control capabilities as part of the administration of control amid operation of the battery paste application machine and use of the hopper assembly 10. Integrated encoders of the first and second servomotors 18, 20 enable closed-loop feedback control capabilities; in the example embodiments herein, the encoders are in the form of absolute rotary encoders. One or more electronic controllers 90 (FIG. 1) can electrically communicate, and be electrically coupled to, the first and second servomotors 18, 20. The electronic controller(s) 90 can be an external controller relative to the first and second servomotors 18, 20, an internal controller relative to the first and second servomotors 18, 20, or a combination of both, per various embodiments. The electronic controller(s) 90 can be employed to carry out closed-loop feedback control capabilities. Lastly, a human-machine-interface (HMI) can be provided for operator management of the automated control of volume and pressure of battery paste via the first and second servomotors 18, 20.

Still, other embodiments of the hopper assembly 10 could be equipped to automate control of only one of volume or pressure of battery paste output and discharge from the battery paste application machine. In the example of solely facilitating automated control of volume, the hopper assembly 10 could only have the first servomotor 18 and could lack the second servomotor 20; and conversely, in the example of solely facilitating automated control of pressure, the hopper assembly 10 could only have the second servomotor 20 and could lack the first servomotor 18.

As used herein, the terms “general” and “generally” and “approximately” are intended to account for the inherent degree of variance and imprecision that is often attributed to, and often accompanies, any design and manufacturing process, including engineering tolerances—and without deviation from the relevant functionality and outcome—such that mathematical precision and exactitude is not implied and, in some instances, is not possible. In other instances, the terms “general” and “generally” and “approximately” are intended to represent the inherent degree of uncertainty that is often attributed to any quantitative comparison, value, and measurement calculation, or other representation.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A battery paste application hopper assembly, comprising:
a housing establishing an interior;
a paste delivery roller situated at said interior of said housing;
a feed roller situated at said interior of said housing, said feed roller located adjacent said paste delivery roller;
a scraper bar situated at said interior of said housing, said scraper bar located downstream a clearance established between said paste delivery roller and said feed roller; and
an actuator having a connection with said scraper bar, wherein actuation of said actuator prompts rotation of said scraper bar.

2. The battery paste application hopper assembly as set forth in claim 1, further comprising a second feed roller, at least one paddle, and a main motor, said second feed roller and said at least one paddle situated at said interior of said housing, said second feed roller located adjacent said feed roller, and wherein said paste delivery roller, said feed roller, said second feed roller, and said at least one paddle rotatable by said main motor amid use of the battery paste application hopper assembly.

3. The battery paste application hopper assembly as set forth in claim 1, wherein said scraper bar has a planar working surface, rotation of said scraper bar via said actuator adjusts an angle of said planar working surface relative to said feed roller.

4. The battery paste application hopper assembly as set forth in claim 1, wherein a first gear is mounted to said scraper bar and a second gear is driven to rotate by said actuator, the connection between said actuator and said scraper bar is via meshing interconnection of said first and second gears.

5. The battery paste application hopper assembly as set forth in claim 1, wherein rotation of said scraper bar via said actuator alters pressure of paste material delivery amid use of the battery paste application hopper assembly.

6. The battery paste application hopper assembly as set forth in claim 1, further comprising a second actuator having a second connection with said feed roller, actuator of said second actuator prompts rotation of said feed roller about an eccentric axis, wherein rotation of said feed roller about said eccentric axis adjusts said clearance established between said feed roller and said paste delivery roller.

7. The battery paste application hopper assembly as set forth in claim 6, wherein a first gear is mounted to said feed roller and a second gear is driven to rotate by said second actuator, the second connection between said second actuator and said feed roller is via meshing interconnection of said first and second gears.

8. The battery paste application hopper assembly as set forth in claim 6, wherein rotation of said feed roller about said eccentric axis via said second actuator alters volume of paste material delivery amid use of the battery paste application hopper assembly.

9. The battery paste application hopper assembly as set forth in claim 6, wherein rotation of said feed roller about said eccentric axis via said second actuator moves said feed roller toward and away from said paste delivery roller.

10. A battery paste application hopper assembly, comprising:
a housing establishing an interior;
a paste delivery roller situated at said interior of said housing;
a feed roller situated at said interior of said housing, said feed roller located adjacent said paste delivery roller, a clearance established at a confrontation between said feed roller and said paste delivery roller; and
an actuator having a connection with said feed roller, said actuator actuatable to rotate said feed roller about an eccentric axis, wherein rotation of said feed roller about said eccentric axis adjusts said clearance established between said feed roller and said paste delivery roller.

11. The battery paste application hopper assembly as set forth in claim 10, wherein said feed roller is caused to rotate about a central axis amid use of the battery paste application hopper assembly to draw the flow of battery paste at said interior, and wherein rotation of said feed roller about said eccentric axis via said actuator alters volume of paste material delivery amid use the battery paste application hopper assembly, and wherein an offset is established between said central axis and said eccentric axis.

12. The battery paste application hopper assembly as set forth in claim 10, wherein a first gear is mounted to said feed roller and has an axis of rotation coinciding with said eccentric axis, and a second gear is driven to rotate by said actuator, the connection between said actuator and said feed roller is via meshing interconnection of said first and second gears.

13. The battery paste application hopper assembly as set forth in claim 10, wherein rotation of said feed roller about said eccentric axis via said actuator moves said feed roller toward and away from said paste delivery roller.

14. A battery paste application hopper assembly, comprising:
a housing establishing an interior;
a paste delivery roller situated at said interior of said housing;
a feed roller located adjacent said paste delivery roller, said feed roller having a first gear, a clearance established at a confrontation between said feed roller and said paste delivery roller;
a scraper bar located downstream of said clearance, said scraper bar having a planar working surface and having a second gear;
a first actuator having a third gear, said first actuator actuatable to rotate said feed roller about an eccentric axis via meshing of said first and third gears, rotation of said feed roller about said eccentric axis adjusting said clearance; and
a second actuator having a fourth gear, said second actuator actuatable to rotate said scraper bar via meshing of said second and fourth gears, rotation of said scraper bar adjusting an angle of said planar working surface relative to said feed roller.

15. The battery paste application hopper assembly as set forth in claim 14, wherein rotation of said feed roller about said eccentric axis moves said feed roller toward and way from said paste delivery roller.

16. The battery paste application hopper assembly as set forth in claim 14, wherein rotation of said feed roller about said eccentric axis via said first actuator alters volume of paste material delivery, and rotation of said scraper bar via said second actuator alters pressure of paste material delivery.

17. The battery paste application hopper assembly as set forth in claim 14, wherein said first actuator is a first servomotor and said second actuator is a second servomotor.

18. The battery paste application hopper assembly as set forth in claim 14, further comprising an electronic controller commanding actuation of said servomotor.

19. A battery paste application machine comprising the battery paste application hopper assembly set forth in claim 14.
